(19) United States
(12) Patent Application Publication
(10) Pub. No.: US 2025/0337052 A1
(43) Pub. Date: Oct. 30, 2025

(54) HEAT INSULATION SHEET FOR RECHARGEABLE LITHIUM BATTERY AND RECHARGEABLE LITHIUM BATTERY MODULE INCLUDING THE SAME

(71) Applicant: SAMSUNG SDI CO., LTD., Yongin-si (KR)

(72) Inventors: Hye Jin PARK, Suwon-si (KR); A Rum YU, Suwon-si (KR); Myung Heui WOO, Suwon-si (KR); Seung Yong YANG, Suwon-si (KR); Jung Hyo LEE, Suwon-si (KR); Jae Hyun LEE, Suwon-si (KR); Ha Na RA, Suwon-si (KR); Yun Sung YANG, Suwon-si (KR)

(73) Assignee: SAMSUNG SDI CO., LTD., Yongin-si (KR)

(21) Appl. No.: 19/189,541

(22) Filed: Apr. 25, 2025

(30) Foreign Application Priority Data
Apr. 30, 2024 (KR) 10-2024-0057492

(51) Int. Cl. H01M 10/658; H01M 10/052; H01M 50/209

(52) U.S. Cl. CPC H01M 10/658; H01M 10/052; H01M 50/209; H01M 2220/20

(57) ABSTRACT

The present disclosure relates to a heat insulation sheet for a rechargeable lithium battery, and a rechargeable lithium battery module including the heat insulation sheet. The heat insulation sheet includes a first base layer and an aerogel-containing layer stacked on the first base layer. The first base layer is a fiber mat, the aerogel-containing layer includes a fibrous support, an aerogel, and a binder. In the aerogel-containing layer, the fibrous support is included in an amount ranging from about 5 wt % to about 70 wt %, the aerogel is included in an amount ranging from about 10 wt % to about 90 wt %, and the binder is included in an amount ranging from about 0.5 wt % to about 20 wt %.

### CROSS-REFERENCE TO RELATED APPLICATION

The present application claims priority to Korean Patent Application No. 10-2024-0057492, filed on Apr. 30, 2024 in the Korean Intellectual Property Office, the entire disclosure of which is incorporated herein by reference.

### BACKGROUND

### 1. Field of the Disclosure

The present disclosure relates to a heat insulation sheet for a rechargeable lithium battery, and a rechargeable lithium battery module including the heat insulation sheet.

### 2. Discussion of Related Art

With increasing presence of electronic devices using batteries, such as, e.g., mobile phones, notebook computers, electric vehicles, and the like, the demand for secondary batteries having high energy density and high capacity is increasing. Therefore, improving the performance of rechargeable lithium batteries may be advantageous.

A rechargeable lithium battery includes a positive electrode and a negative electrode that contain an active material capable of the intercalation and deintercalation of lithium ions, and produces electrical energy by oxidation and reduction reactions when the lithium ions are intercalated into and deintercalated from the positive electrode and the negative electrode.

A plurality of rechargeable lithium batteries may be included to form a rechargeable lithium battery module. In the rechargeable lithium battery module, it may be advantageous to block heat propagation and/or heat transfer between adjacent cells.

### SUMMARY

One example embodiment is directed to a heat insulation sheet for a rechargeable lithium battery with desired or improved durability, dust resistance, heat insulation, and flexibility.

Another example embodiment is directed to a rechargeable lithium battery module including the heat insulation sheet for a rechargeable lithium battery.

According to one example embodiment, a heat insulation sheet for a rechargeable lithium battery includes a first base layer, and an aerogel-containing layer stacked on the first base layer. The first base layer is a fiber mat, the aerogel-containing layer includes a fibrous support, an aerogel, and a binder. In the aerogel-containing layer, the fibrous support is included in an amount ranging from about 5 wt % to about 70 wt %, the aerogel is included in an amount ranging from about 10 wt % to about 90 wt %, and the binder is included in an amount ranging from about 0.5 wt % to about 20 wt %.

According to another example embodiment, a rechargeable lithium battery module includes a plurality of battery cells that face each other, and the heat insulation sheet for a rechargeable lithium battery, which is disposed between the plurality of battery cells.

### BRIEF DESCRIPTION OF THE DRAWINGS

FIG. 1 is a cross-sectional view of a heat insulation sheet for a rechargeable lithium battery, according to one example embodiment.

FIG. 2 is a cross-sectional view of a heat insulation sheet for a rechargeable lithium battery, according to another example embodiment.

FIG. 3 is a perspective view of a rechargeable lithium battery module, according to one example embodiment.

FIG. 4 is an exploded perspective view of the rechargeable lithium battery module, according to one example embodiment.

FIG. 5 is a cross-sectional view schematically illustrating a battery cell, according to one example embodiment.

FIG. 6 is a cross-sectional view schematically illustrating a battery pack, according to one example embodiment.

FIG. 7 is a cross-sectional view schematically illustrating the battery pack, according to one example embodiment.

FIG. 8 is a view showing a vehicle body and vehicle body parts, according to one example embodiment.

FIG. 9 is a view showing a vehicle body and vehicle body parts, according to one example embodiment.

### DETAILED DESCRIPTION

Hereinafter, example embodiments of the present disclosure are described in detail. However, the example embodiments are presented as examples, and the present disclosure is not limited thereto, and the present disclosure is only defined by the scope of the appended claims.

Unless otherwise stated herein, when a part such as a layer, a membrane, an area, a plate, and the like, is described as being disposed “on” another part, it includes not only a case where the part is “directly on” another part, but also a case where there are other parts therebetween.

Unless otherwise stated herein, the singular may also include the plural. In addition, unless otherwise stated, “A or B” may indicate “including A, including B, or including A and B.”

In the present specification, “a combination thereof” may indicate a mixture, stack, composite, copolymer, alloy, blend, and reaction product of constituents.

In the present specification, “flexural modulus” of the heat insulation sheet may be a value measured according to ASTM D790.

When the terms “about” or “substantially” are included in this specification in connection with a numerical value, it is intended that the associated numerical value include a tolerance of ±10% around the stated numerical value. When ranges are specified, the range includes all values therebetween such as increments of 0.1%.

### Heat Insulation Sheet for a Rechargeable Lithium Battery:

A heat insulation sheet for a rechargeable lithium battery according to one example embodiment includes a first base layer, and an aerogel-containing layer stacked on the first base layer, in which the first base layer is or includes a fiber mat, and the aerogel-containing layer includes a fibrous support, an aerogel, and a binder. In the aerogel-containing layer, the fibrous support is included in an amount ranging from about 5 wt % to about 70 wt %, the aerogel is included in an amount ranging from about 10 wt % to about 90 wt %, and the binder is included in an amount ranging from about 0.5 wt % to about 20 wt %.

The heat insulation sheet according to one example embodiment may further include a second base layer stacked on the aerogel-containing layer.

The heat insulation sheet has a form in which the aerogel-containing layer is stacked on the first base layer, and the first base layer and the aerogel-containing layer are independent separate layers. The heat insulation sheet includes the first base layer, which is or includes a fiber mat, and the aerogel-containing layer includes the fibrous support, the aerogel, and the binder within the above content ranges, respectively, thereby exhibiting desired or improved durability, heat insulation, dust resistance, and flexibility.

According to one example embodiment, the heat insulation sheet may have a flexural modulus of about 0.1 MPa or less, for example, ranging from about 0.01 MPa to about 0.1 MPa. Within the above range, the heat insulation sheet including the first base layer and the aerogel-containing layer (which further includes the second base layer) may have desired or improved flexibility.

Hereinafter, the heat insulation sheet according to one example embodiment is described in detail.

### First Base Layer

The first base layer is or includes a fiber mat. The fiber mat may be or include a non-woven sheet in which short length fibers are substantially randomly oriented. The durability of the heat insulation sheet can be improved by including the fiber mat as the first base layer.

The first base layer may have a thickness ranging from about 0.1 mm to about 10 mm, for example, from 0.3 mm to 5 mm, from 0.5 mm to 3 mm, from 0.5 mm to 2 mm, or from 0.5 mm to 1 mm. Within the above range, the first base layer may be included in the heat insulation sheet.

The first base layer may be included in one or more layers, that is, one layer or two or more layers in the heat insulation sheet.

According to one example embodiment, the fiber may be or include a glass fiber. For example, the glass fiber may be an E glass or C glass fiber.

According to one example embodiment, the first base layer may be or include a fiber glass mat. The aerogel-containing layer to be described below may have desired or improved durability, dust resistance, heat insulation, and flexibility improvement effects with respect to the above-described first base layer, in particular, the glass fiber mat.

### Aerogel-Containing Layer

The aerogel-containing layer may be stacked on one surface, or on both surfaces, of the first base layer. The aerogel-containing layer may face, or not face, the battery cells in the rechargeable lithium battery module. The aerogel-containing layer may provide a heat insulation effect even when not facing the battery cells.

The aerogel-containing layer may be a separate layer that is independent of the first base layer. Herein, “separate layer that is independent of” indicates that the aerogel-containing layer is not formed through impregnation, and the like, in the first base layer, but that the first base layer and the aerogel-containing layer are formed as layers that are completely separated and noncontinuous. The aerogel-containing layer may be formed directly on the first base layer. Herein, “directly formed” indicates that there is no adhesive layer or bonding layer between the aerogel-containing layer and the first base layer.

The aerogel-containing layer may be included in one or more layers, that is, one layer or two or more layers in the heat insulation sheet.

The aerogel-containing layer includes a fibrous support, an aerogel, and a binder.

The fibrous support may support the aerogel-containing layer and can improve the heat insulation, durability, and dust resistance of the heat insulation sheet together with the first base layer.

For example, the fibrous support may be or include a wool mat or a chopped strand mat.

Fibers constituting the fibrous support may include one or more of natural fibers, glass fibers, carbon fibers, graphite fibers, mineral fibers, and polymer fibers. For example, it is possible to further improve the flexibility of the heat insulation sheet using glass fiber as the fibrous support.

The natural fiber may be a fiber made of or including one or more of hemp, jute, flax, coir, kenaf, and cellulose. The mineral fiber may be a fiber made of or including one or more of basalt, wollastonite, alumina, silica, slag, and rock. The polymer fiber may be a fiber made of or including one or more of nylons, polyimides; polyamides, polybenzimidazoles, polybenzoxazoles, polyamide-imides, polyesters such as polyethylene terephthalate and polybutylene terephthalate, and polyolefins such as polyethylene and polypropylene.

For example, the fibrous support may be or include glass wool.

The fibers in the fibrous support may have an aspect ratio ranging from about 1 to about 5000, for example, from 300 to 5000 or from 2.5 to 2500. Within the above range, the aerogel-containing layer can be firmly formed, and the durability of the heat insulation sheet can be improved. Herein, “aspect ratio” is a ratio of a length of the fiber to a diameter of the fiber in the fibrous support.

The fiber in the fibrous support may have a length ranging from about 50 μm to about 20,000 μm, for example, from 100 μm to 5,000 μm or from 3,000 μm to 50,000 μm. Within the above range, the aerogel-containing layer can be firmly formed, and the durability of the heat insulation sheet can be improved.

The fibers in the fibrous support may have a diameter ranging from about 0.1 μm to about 20 μm, for example, from 0.1 μm to 15 μm, from 0.1 μm to 5 μm, from 1 μm to 15 μm, or from 3 μm to 10 μm. Within the above range, the aerogel-containing layer can be firmly formed, and the durability of the heat insulation sheet can be improved. Herein, “diameter” may be a diameter when a cross section of the fiber is circular, and may be the longest diameter when the above cross section is not circular.

The fibrous support may be contained in an amount ranging from about 5 wt % to about 70 wt % of the aerogel-containing layer. For example, the fibrous support may be contained in an amount ranging from 25 wt % to 60 wt %, from 25 wt % to 50 wt %, or from 25 wt % to 40 wt % of the aerogel-containing layer. Within the above range, it is possible to readily improve the flexibility and durability of the heat insulation sheet. The aerogel may provide the heat insulating effect to the aerogel-containing layer.

According to one example embodiment, the aerogel may have a specific surface area ranging from about 500 m²/g to about 1000 m²/g. For example, the specific surface area may range from 500 m²/g to 950 m²/g, from 550 m²/g to 950 m²/g, or from 600 m²/g to 900 m²/g. Within the above range, it is possible to readily reduce or prevent heat transfer and heat propagation between a plurality of battery cells. Herein, “specific surface area” may refer to a specific surface area based on Brunauer Emmett Teller (BET) specific surface area analysis.

According to one example embodiment, the aerogel may have an average particle diameter ranging from about 5 μm to about 200 μm. For example, the aerogel may have an average particle diameter ranging from 10 μm to 100 μm or from 20 μm to 50 μm. Within the above range, it is possible to readily delay heat transfer between a plurality of battery cells by improving the heat insulation properties of the heat insulation sheet.

According to one example embodiment, the aerogel may be hydrophobically treated. Herein, an aerogel that has not been hydrophobically treated is vulnerable to moisture, in the process, moisture is evaporated after slurrying to obtain a heat insulation sheet, but it takes a long time for moisture to evaporate and increases the possibility of cracks occurring in the heat insulation sheet, and even after the heat insulation sheet is manufactured, there is a high possibility of absorbing moisture, which can lower reliability. The hydrophobic treatment may be performed on an aerogel that has not been surface-treated using conventional methods known to those skilled in the art.

The aerogel may be contained in an amount ranging from about 10 wt % to about 90 wt % of the aerogel-containing layer. For example, the aerogel may be contained in an amount ranging from 30 wt % to 70 wt %, from 40 wt % to 65 wt %, or from 40 wt % to 60 wt % of the aerogel-containing layer. Within the above range, the heat insulation properties of the heat insulation sheet can be increased.

The binder can make it possible to improve the dust resistance and durability of the heat insulation sheet.

According to one example embodiment, the binder may be or include a water-based binder. The water-based binder has high solubility in water among solvents described below, and thus may allow the aerogel-containing layer to be readily formed.

According to one example embodiment, the water-based binder may include one or more of a cationic water-soluble polymer, an anionic water-soluble polymer, and a nonionic water-soluble polymer.

The cationic water-soluble polymer may be or include a polymer having a functional group such as or including at least one of an amine group, an ammonium group, a phosphonium group, a sulfonium group, or a salt thereof, for example, a polymer having an amine group. For example, the cationic water-soluble polymer may include one or more of polyethyleneamine and polyamine.

The anionic water-soluble polymer may be or include a polymer having a functional group such as or including at least one of a carboxylic acid group, a sulfonic acid group, an ester group, a phosphoric acid ester group, or a salt thereof, for example, a polymer having a carboxylic acid group. For example, the anionic water-soluble polymer may be or include polymaleic acid.

The nonionic water-soluble polymer may include one or more of polyvinyl alcohol, polyethylene glycol, polyacrylamide, polyvinylpyrrolidone, polyurethane, and polyester. The nonionic water-soluble polymer may be or include a water-dispersible or water-based polymer.

According to one example embodiment, the binder may contain a mixture of one or more of polyvinyl alcohol, polyethylene glycol, polyacrylamide, and polyvinylpyrrolidone, and one or more of polyurethane and polyester. In this case, it may be possible to provide dispersion characteristics by one or more of polyvinyl alcohol, polyethylene glycol, polyacrylamide, and polyvinylpyrrolidone, and fire resistance properties by one or more of polyurethane and polyester.

For example, one or more of polyvinyl alcohol and polyurethane may be included as the binder.

According to one example embodiment, a weight ratio of one or more of polyvinyl alcohol, polyethylene glycol, polyacrylamide, and polyvinylpyrrolidone to one or more of polyurethane and polyester ranges from about 1:1 to about 1:5, for example, from 1:1 to 1:4 or from 1:2 to 1:3. Within the above range, the heat insulation, dust resistance, fire resistance, and mechanical properties of the heat insulation sheet can be improved.

The binder may be contained in an amount ranging from about 0.5 wt % to about 20 wt % of the aerogel-containing layer. When the binder is contained in an amount of 0.5 wt % or more, the dust resistance and durability of the heat insulation sheet can be improved. When the binder is contained in an amount of 20 wt % or less, the heat insulation and durability of the heat insulation sheet can be improved. For example, the binder may be contained in an amount ranging from 2 wt % to 15 wt %, from 5 wt % to 15 wt %, or from 8 wt % to 15 wt % of the aerogel-containing layer. Within the above range, it is possible to readily improve the durability, heat insulation, dust resistance, and flexibility of the heat insulation sheet.

According to one example embodiment, a total of the fibrous support, the aerogel, and the binder may be contained in an amount of about 95 wt % or more, for example, ranging from 95 wt % to 100 wt %, from 99 wt % to 100 wt %, or 100 wt % of the aerogel-containing layer. Within the above range, the above effects of the heat insulation sheet can be readily realized.

The aerogel-containing layer may be formed using a composition for an aerogel-containing layer including the fibrous support, the aerogel, and the binder. This is described below.

The aerogel-containing layer may further include one or more of a dispersant and a silane-based compound.

The dispersant can improve the dispersion of the aerogel in the composition for the aerogel-containing layer, thereby enabling the manufacturing of an aerogel-containing layer in which the fibrous support and the aerogel are uniformly dispersed.

The dispersant may include one or more of a surfactant and a phosphorus salt. The surfactant may include one or more of a nonionic surfactant, anionic surfactant, and zwitterionic surfactant. The surfactant may include one or more of natural surfactants such as lecithin, and non-natural surfactants such as chemicals. The phosphorus salt may be or include a phosphate-based salt.

The aerogel may be contained in an amount ranging from about 0.1 wt % to about 6 wt % of the aerogel-containing layer. For example, the dispersant may be contained in an amount ranging from 0.1 wt % to 5 wt % or from 0.1 wt % to 3 wt %. Within the above range, it is possible to manufacture a composition for an aerogel-containing layer at low cost, and provide a heat insulation sheet with further improved heat insulation, durability, and dust resistance.

According to one example embodiment, the binder and the dispersant may be included in a weight ratio of about 1:0.001 to about 1:0.7, for example, 1:0.001 to 1:0.67, 1:0.001 to 1:0.5, or 1:0.001 to 1:0.3. Within the above range, when the binder and the dispersant are included together, it is possible to manufacture an aerogel-containing layer in which the aerogel is further uniformly dispersed.

The silane-based compound can improve the dispersibility of the aerogel in the aerogel-containing layer.

According to one example embodiment, the silane-based compound may include one or more of alkyl group-containing trialkoxysilanes such as methyltrimethoxysilane, methyltriethoxysilane, ethyltrimethoxysilane, ethyltriethoxysilane, or octadecyltrimethoxysilane, epoxy group-containing trialkoxysilanes such as glycidoxypropyltrimethoxysilane, and unsaturated group-containing trialkoxysilanes such as 3-(trimethoxysilyl) propyl methacrylate.

The aerogel-containing layer may further include typical additives known to those skilled in the art. The additives may include one or more of wetting agents, emulsifiers, compatibilizers, viscosity regulators, pH regulators, stabilizers, antioxidants, acidic or basic trapping agents, metal deactivators, antifoaming agents, antistatic agents, thickeners, adhesion promoters, binders, flame retardants, impact modifiers, pigments, dyes, colorants, and deodorants.

According to one example embodiment, the aerogel-containing layer may have a thickness ranging from about 0.01 mm to about 10 mm, for example, from 0.5 mm to 5 mm, from 0.1 mm to 3 mm, from 0.5 mm to 2 mm, or from 1 mm to 2 mm. Within the above range, the aerogel-containing layer may be included in the heat insulation sheet.

### Second Base Layer

The second base layer may support the aerogel-containing layer of the heat insulation sheet.

The second base layer may be stacked on the aerogel-containing layer. The aerogel-containing layer may be a separate layer that is independent of the second base layer. Herein, “separate layer that is independent of” indicates that the aerogel-containing layer is not formed through impregnation, and the like, in the second base layer, but that the second base layer and the aerogel-containing layer are formed as layers that are completely separated and noncontinuous.

The second base layer may be included in one or more layers, that is, one layer or two or more layers in the heat insulation sheet.

The second base layer may be or include a fiber mat. The fiber mat may be or include a non-woven sheet in which short length fibers are substantially randomly oriented. The heat insulation sheet may have improved flexibility by including the fiber mat as the second base layer.

According to one example embodiment, the fiber may be or include a glass fiber. For example, the glass fiber may be an E glass or C glass fiber.

According to one example embodiment, the second base layer may be or include a fiber glass mat.

The second base layer may have a thickness ranging from about 0.1 mm to about 10 mm, for example, from 0.3 mm to 5 mm, from 0.5 mm to 3 mm, from 0.5 mm to 2 mm, or from 0.5 mm to 1 mm. Within the above range, the aerogel-containing layer may be included in the heat insulation sheet.

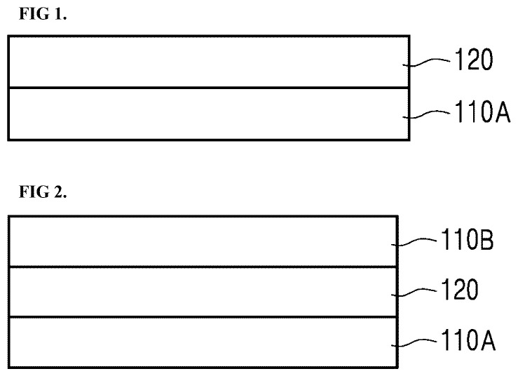

FIGS. 1 and 2 are cross-sectional views of the heat insulation sheet, according to one example embodiment.

Referring to FIG. 1, the heat insulation sheet may include a first base layer 110A and an aerogel-containing layer 120 stacked on one surface of the first base layer 110A.

Referring to FIG. 2, the heat insulation sheet may include a first base layer 110A and a second base layer 110B facing each other, and an aerogel-containing layer 120 between the first base layer 110A and the second base layer 110B.

Hereinafter, a method of manufacturing the heat insulation sheet according to one example embodiment is described.

The method of manufacturing the heat insulation sheet may include preparing a composition for an aerogel-containing layer containing a fibrous support, an aerogel, and a binder, coating a base layer with the composition for an aerogel-containing layer, and drying the composition for an aerogel-containing layer coated on the base layer.

The composition for an aerogel-containing layer includes a fibrous support, an aerogel, and a binder. The fibrous support, the aerogel, and the binder are the same as described above.

The composition for an aerogel-containing layer may further include one or more of the dispersant, the silane-based compound, and the additive.

The composition for an aerogel-containing layer may further include a solvent.

The solvent may include one or more of a polar solvent and a non-polar solvent.

The polar solvent may include at least one of water, an alcohol-based solvent, or a combination thereof. The water may include, for example, at least one of purified water, ultrapure water, or a combination thereof. The alcohol-based solvent may include, for example, one or more of methanol, ethanol, propanol, pentanol, butanol, hexanol, ethylene glycol, propylene glycol, diethylene glycol, and glycerol.

The non-polar solvent may include a hydrocarbon-based solvent. For example, the hydrocarbon-based solvent may include one or more of aliphatic hydrocarbon solvents such as or including at least one of hexane, pentane, and heptane, for example, alkane solvents and aromatic hydrocarbon solvents such as toluene and benzene.

For example, the solvent may include water. When water is included as a solvent, raw material costs and post-treatment costs can be effectively reduced.

The solvent may be contained so that a weight ratio of the solvent to a total solid content of the composition for an aerogel-containing layer ranges from about 1:1 to about 10:1. For example, the weight ratio of the solvent to the total solid content of the composition for an aerogel-containing layer may range from 1:1 to 10:1, from 1.5:1 to 5:1, or from 2:1 to 4:1. Within the above range, the composition for an aerogel-containing layer may be coated by controlling the viscosity of the composition for an aerogel-containing layer.

The composition for an aerogel-containing layer may be prepared using the solvent, the fibrous support, the aerogel, and the binder.

According to one example embodiment, the composition for an aerogel-containing layer may include preparing a first mixed solution by mixing the binder with the solvent, preparing a second mixed solution by mixing an aerogel with the first mixed solution, and preparing the composition for an aerogel-containing layer by mixing the fibrous support with the second mixed solution. In the preparing of the first mixed solution, the dispersant, the silane-based compound, the additive, and the like, may be additionally mixed.

When mixing in each of the first operation, the second operation, and the preparing of the composition for an aerogel-containing layer, the mixing may be performed using a mixer. Examples of the mixer may include a planetary mixer, a Thinky mixer, and the like.

The planetary mixer may include one or more types of planetary blades and one or more types of high-speed dispersion blades. The planetary blade and the high-speed dispersion blade rotate continuously about their axes. A rotational speed may be expressed in revolutions per minute (rpm).

According to one example embodiment, the planetary mixer may include a first blade and a second blade that have different rotational axes. For example, the first blade may be a low-speed blade, and the second blade may be a high-speed blade. Here, low speed and high speed are relative rotational speeds. For example, the first blade may be an open blade, and the second blade may be a Despa blade. A rotational speed of the first blade may range from, for example, about 10 rpm to about 100 rpm or from 10 rpm to 60 rpm. A rotational speed of the second blade may range from about 100 rpm to about 2000 rpm.

The aerogel-containing layer may be prepared by applying the composition for an aerogel-containing layer, and then drying the composition. The drying may be performed at a temperature ranging from about 25° C. to about 100° C., from 45° C. to 90° C., and from 60° C. to 85° C. Within the above range, an aerogel-containing layer with desired or improved mechanical strength may be formed without a separate adhesive member or an adhesive, while reducing or preventing peeling between the first base layer and the aerogel-containing layer, and reducing or preventing peeling between the aerogel-containing layer and the second base layer.

According to one example embodiment, before performing the drying, a second base layer may be additionally stacked on the applied composition for an aerogel-containing layer.

### Rechargeable Lithium Battery:

Another example embodiment includes a rechargeable lithium battery module including a plurality of battery cells that face each other, and heat insulating sheets for a rechargeable lithium battery between the plurality of battery cells.

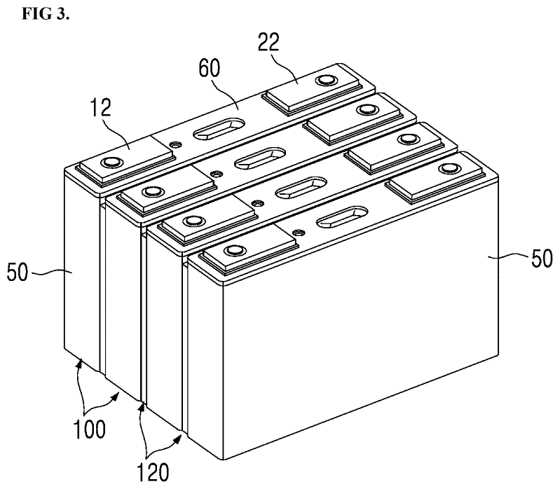

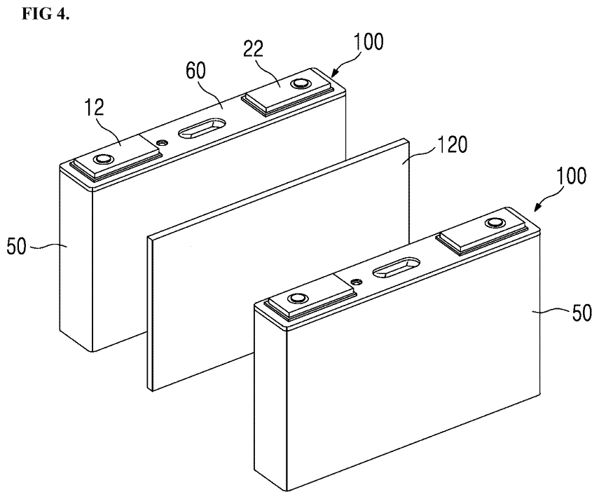

FIGS. 3 and 4 are a perspective view and an exploded perspective view, respectively, of a rechargeable lithium battery module, according to one example embodiment.

Referring to FIGS. 3 and 4, a rechargeable lithium battery module may include a plurality of battery cells 100 that face each other; and heat insulating sheets 200 between the battery cells 100.

The heat insulating sheet 200 for a rechargeable lithium battery may have a plate shape. One surface of the heat insulating sheet 200 may come in contact with one surface of one battery cell 100, and the other surface of the heat insulating sheet 200 opposite to the one surface thereof may come in contact with one surface of another battery cell 100.

The battery cell 100 may include a case 50 configured to accommodate an electrode assembly including a positive electrode and a negative electrode; a cap plate 60 coupled to the case 50 to seal the case 50; and a positive electrode terminal 12, and a negative electrode terminal 22 electrically respectively connected to the positive electrode and to the negative electrode of the electrode assembly, and protruding outside of the cap plate 60.

The positive electrode may include a current collector, and a positive electrode active material layer formed on the current collector. The positive electrode active material layer may include a positive electrode active material, and may further include a binder and/or a conductive additive.

The content of the positive electrode active material may range from about 90 wt % to about 99.5 wt % with respect to 100 wt % of the positive electrode active material layer, and the content of the binder and the content of the conductive additive may each be in a range of about 0.5 wt % to about 5 wt % with respect to 100 wt % of the positive electrode active material layer.

Al may be included as the current collector, but the current collector is not limited thereto.

As the positive electrode active material, a compound capable of reversible intercalation and deintercalation of lithium (a lithiated intercalation compound) may be included. For example, one or more of composite oxides of lithium and a metal such as or including at least one of cobalt, manganese, nickel and a combination thereof may be included.

The composite oxides may be or include lithium transition metal composite oxides. Examples of the composite oxides may include at least one of lithium nickel oxide, lithium cobalt oxide, lithium manganese oxide, a lithium iron phosphate compound, cobalt-free nickel-manganese oxide, or a combination thereof.

As one example, a compound represented by any one of the following chemical formulas may be included as the composite oxide. LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0≤b≤2); LiₐNi_{b}Co_{c}L¹_{d}GₑO₂(0.90≤b≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn₁₋₆G_{b}O₂(0.90≤a≤1.8, 0.001≤b≤0.1); LiₐMn₂GbO₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The negative electrode includes a current collector and a negative electrode active material layer located on the current collector. The negative electrode active material layer may include a negative electrode active material, and may further include a binder and/or a conductive additive.

For example, the negative electrode active material layer may include about 90 wt % to about 99 wt % of the negative electrode active material, about 0.5 wt % to about 5 wt % of the binder, and about 0 wt % to about 5 wt % of the conductive additive.

The negative electrode active material includes a material capable of reversible intercalation/deintercalation of lithium ions, lithium metal, a lithium metal alloy, a material capable of doping and dedoping lithium, or a transition metal oxide.

The material capable of reversible intercalation/deintercalation of lithium ions is a carbon-based negative electrode active material, and may include, for example, crystalline carbon, amorphous carbon, or a combination thereof. Examples of the crystalline carbon may include graphite such as natural graphite or artificial graphite, and examples of the amorphous carbon may include at least one of soft carbon, hard carbon, mesophase pitch carbide, and calcinated coke.

A Si-based negative electrode active material or a Sn-based negative electrode active material may be included as the material capable of doping and dedoping lithium. The Si-based negative electrode active material may be or include at least one of silicon, a silicon-carbon composite, SiOₓ (0<x<2), an Si-based alloy, or a combination thereof.

The silicon-carbon composite may be or include a composite of silicon and amorphous carbon. According to one example embodiment, the silicon-carbon composite may include a silicon particle, and amorphous carbon coated on a surface of the silicon particle.

The silicon-carbon composite may further include crystalline carbon. For example, the silicon-carbon composite may include a core including crystalline carbon and a silicon particle, and an amorphous carbon coating layer located on a surface of the core.

A nonaqueous binder, an aqueous binder, a dry binder, or a combination thereof may be included as the binder. When the aqueous binder is included as the negative electrode binder, a cellulose-based compound that can impart viscosity may be further included.

As the negative electrode current collector, at least one of copper foil, nickel foil, stainless steel foil, titanium foil, nickel foam, copper foam, a polymer substrate having a conductive metal coated thereon, or combinations thereof may be included.

An electrolyte for a rechargeable lithium battery includes a nonaqueous organic solvent and a lithium salt.

The nonaqueous organic solvent is configured as a medium through which ions involved in an electrochemical reaction of a battery can move.

The nonaqueous organic solvent may be or include at least one of a carbonate-based, ester-based, ether-based, ketone-based, or alcohol-based solvent, an aprotic solvent, or a combination thereof. Any of the above may be included alone as the nonaqueous organic solvent, or two or more of the above may be mixed as the nonaqueous organic solvent.

When the carbonate-based solvent is included, a cyclic carbonate and a chain carbonate may be mixed.

A separator may be present between a positive electrode and a negative electrode according to the type of rechargeable lithium battery. At least one of polyethylene, polypropylene, polyvinylidene fluoride, or a multi-layer film of two or more thereof may be included as the separator.

The separator may include a porous base, and a coating layer located on one surface, or on both surfaces, of the porous base and including an organic material, an inorganic material, or a combination thereof.

The organic material may include a polyvinylidene fluoride-based polymer or a (meth)acryl-based polymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and inorganic material may be mixed in a single coating layer, or may be in a form in which a coating layer including the organic material and a coating layer including the inorganic material are stacked together.

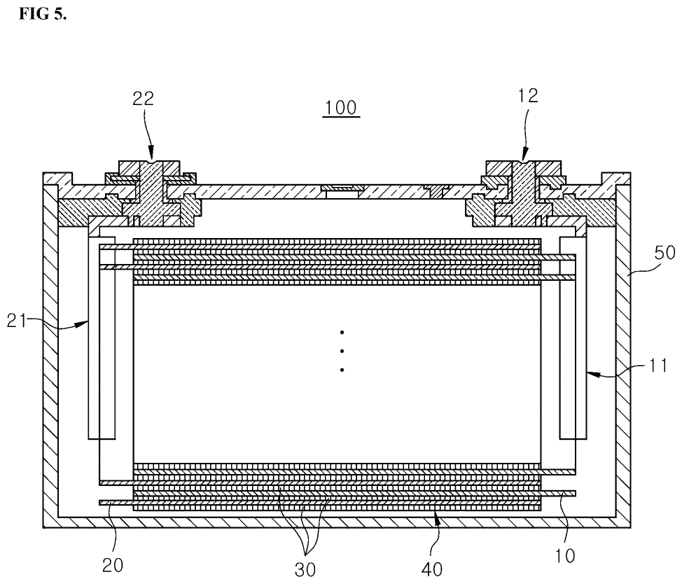

FIG. 5 is a cross-sectional view schematically illustrating the battery cell 100, according to one example embodiment.

Referring to FIG. 5, the battery cell 100 may include an electrode assembly 40 including a positive electrode 10, a negative electrode 20, and a separator 30 interposed between the positive electrode 10 and the negative electrode 20; a case 50 in which the electrode assembly 40 is accommodated; a positive electrode lead tab 11 connected to the positive electrode 10; a positive electrode terminal 12 connected to the positive electrode lead tab 11; a negative electrode lead tab 21 connected to the negative electrode 20; and a negative electrode terminal 22 connected to the negative electrode lead tab 21.

The rechargeable lithium battery module according to one example embodiment may be applicable to vehicles, mobile phones, and/or various other forms of electric devices, but the present disclosure is not limited thereto.

The battery module according to the above-described example embodiment may be used in manufacturing a battery pack.

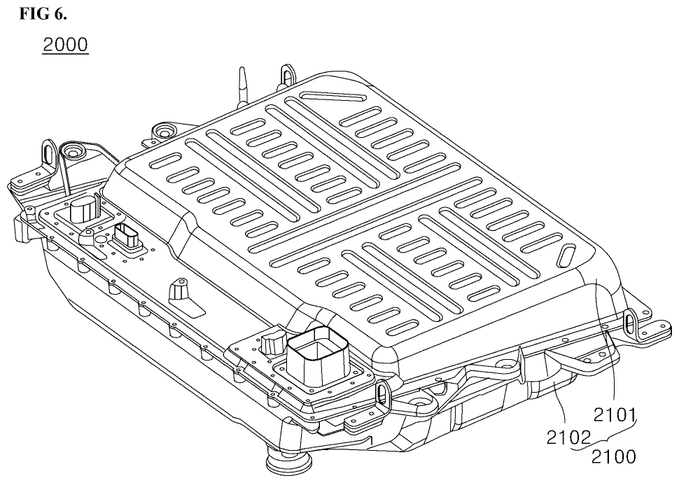

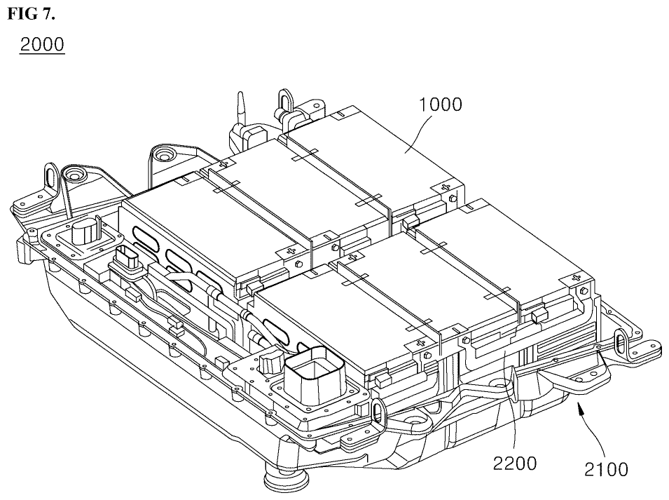

FIG. 6 is a view illustrating a battery pack according to one example embodiment. FIG. 7 is a view illustrating a battery pack according to one example embodiment.

A battery pack 2000 according to one example embodiment includes an assembly of electrically connected individual batteries, and a pack case accommodating the same. In the drawings, for convenience of illustration of the drawings, illustration of components such as a busbar, a cooling unit, an external terminal, and the like for electrical connection of batteries has been omitted.

For example, the battery pack 2000 may include a plurality of battery modules 1000 (for example, including the battery module described above with reference to FIG. 5) and a pack case 2100 for accommodating the battery modules 1000. For example, the pack case 2100 may include first and second pack cases 2101 and 2102 coupled to each other in directions facing each other while the plurality of battery modules 1000 are interposed therebetween. The plurality of battery modules 1000 may be electrically connected to each other using a busbar 2200, or the plurality of battery modules 1000 may be electrically connected to each other in series or in parallel, or by a combination of serial and parallel connections, to obtain a required electrical output.

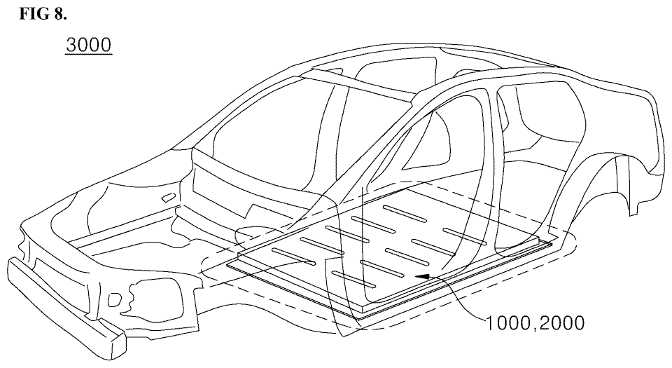

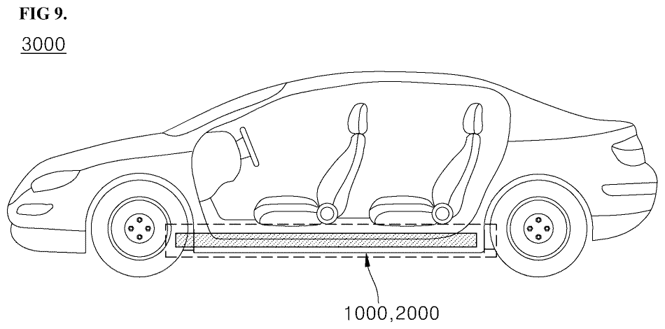

FIG. 8 is a view illustrating a vehicle body and vehicle body components, according to one example embodiment.

FIG. 9 is a view illustrating a vehicle body and vehicle body components, according to one example embodiment.

The battery pack 2000 according to one example embodiment described above with reference to FIGS. 6 and 7 may be mounted in a vehicle 3000. For example, the vehicle 3000 may be an electric vehicle, a hybrid vehicle, a plug-in hybrid vehicle, or the like. The vehicle may be a four-wheel vehicle, a two-wheel vehicle, or the like.

As illustrated in FIGS. 8 and 9, the vehicle 3000 according to one example embodiment includes the battery modules 1000 and/or the battery pack 2000 including the battery modules 1000 according to one example embodiment of the present disclosure. The vehicle 3000 operates by receiving power from the battery modules 1000 and/or the battery pack 2000 including the battery modules 1000 according to one example embodiment of the present disclosure.

Hereinafter, examples and comparative examples of the present disclosure are described. However, the following examples are merely embodiments of the present disclosure, and the present disclosure is not limited to the following examples.

### Example 1

A first mixed solution was prepared by adding polyvinyl alcohol (Sigma Aldrich) as a binder to ultrapure water as a solvent and sequentially mixing the same at 30 rpm with an open blade and 700 rpm with a Despa blade. A second mixed solution was prepared by adding an aerogel (BET specific surface area: 800 m²/g) to the first mixed solution and sequentially mixing the same at 70 rpm with the open blade and 1500 rpm with the Despa blade. A composition for an aerogel-containing layer was prepared by adding glass wool to the second mixed solution and sequentially mixing the same at 30 rpm with the open blade and 1200 rpm with the Despa blade. A planetary mixer (D&Tech, PT-005) was included for mixing.

The prepared composition for an aerogel-containing layer was in the form of a slurry, and included, based on solid content, 50 wt % aerogel, 40 wt % glass wool, and 10 wt % polyvinyl alcohol.

The prepared composition for an aerogel-containing layer was applied on the fiber glass mat (thickness: 0.6 mm), and the fiber glass mat (thickness: 0.6 mm) was stacked on the composition for an aerogel-containing layer and coated using a roll rolling method. Then, a heat insulation sheet stacked in the order of the fiber glass mat-the aerogel-containing layer-the fiber glass mat was manufactured by drying the stack at 60° C. for 24 hours. A thickness of the aerogel-containing layer was 1.8 mm, and a thickness of the heat insulation sheet was 3 mm.

### Example 2

A heat insulation sheet was manufactured in the same manner as in Example 1, with a difference that in Example 1, the solid content of the composition for an aerogel-containing layer was changed to 60 wt % aerogel, 25 wt % glass wool, and 15 wt % polyvinyl alcohol.

### Example 3

A heat insulation sheet was manufactured in the same manner as in Example 1, with a difference that in Example 1, the solid content of the composition for an aerogel-containing layer was changed to 65 wt % aerogel, 25 wt % glass wool, and 10 wt % polyvinyl alcohol.

### Example 4

A heat insulation sheet was manufactured in the same manner as in Example 1, with a difference that in Example 1, the solid content of the composition for an aerogel-containing layer was changed to 45 wt % aerogel, 50 wt % glass wool, and 5 wt % polyvinyl alcohol.

### Example 5

A heat insulation sheet was manufactured in the same manner as in Example 1, with a difference that in Example 1, a water-dispersible polyurethane instead of polyvinyl alcohol was included when preparing the composition for an aerogel-containing layer.

### Comparative Example 1

A composition for an aerogel-containing layer was prepared in the same manner as in Example 1.

The prepared composition for an aerogel-containing layer was applied on a mica sheet (Famica, Muscovite) with a thickness of 0.3 mm, and a mica sheet (Famica, Muscovite) with a thickness of 0.3 mm was stacked on the composition for an aerogel-containing layer and coated using a roll rolling method. Subsequently, a heat insulation sheet stacked in the order of the mica sheet-the aerogel-containing layer-the mica sheet was manufactured by drying the stack at 60° C. for 24 hours. In this case, a thickness of the aerogel-containing layer was 2.4 mm, and a thickness of the heat insulation sheet was 3 mm.

### Comparative Example 2

A heat insulating layer was prepared. The heat insulating layer was formed by impregnating a glass wool blanket with an aerogel precursor under low temperature and reduced pressure, and gelling and then supercritical-drying the same. In this case, the heat insulating layer contained 45 wt % aerogel, 45 wt % glass wool, and 10 wt % binder. A heat insulation sheet, which had a total thickness of 3 mm and was stacked in the order of a mica sheet-an adhesive layer-a heat insulating layer-an adhesive layer-a mica sheet, was manufactured by forming an adhesive layer with a thickness of 0.05 mm on each of upper and lower surfaces of the heat insulating layer using lamination, hot melting, or a double-sided tape and attaching a mica sheet with a thickness of 0.3 mm to each adhesive layer.

### Comparative Example 3

A heat insulation sheet was manufactured in the same manner as in Example 1, with a difference that in Example 1, the solid content of the composition for an aerogel-containing layer was changed to 50 wt % aerogel, 49.7 wt % glass wool, and 0.3 wt % polyvinyl alcohol.

### Comparative Example 4

A heat insulation sheet was manufactured in the same manner as in Example 1, with a difference that in Example 1, the solid content of the composition for an aerogel-containing layer was changed to 40 wt % aerogel, 35 wt % glass wool, and 25 wt % polyvinyl alcohol.

The following physical properties of the manufactured heat insulation sheet were evaluated and are shown in Table 1 below.

(1) Heat insulation (units: ° C.): The heat insulation sheet was inserted between a pair of facing 1 mm-thick aluminum plates, the same was placed on the heat press, the upper plate of the heat press was heated at 350° C., and the lower plate of the heat press was maintained at 40° C. without heating. Subsequently, a pressure of 20 kN was applied to the lower plate of the heat press, and a temperature of the lower plate of the heat press was measured after 11 minutes. The lower the temperature, the better the heat insulation.

(2) Dust resistance (units: %): Samples were manufactured by cutting the manufactured heat insulation sheet into a length of 12 inches and a width of 12 inches, and a weight of the sample was measured. The weight of the sample was measured after vibrating the sample under vibration conditions (frequency: 24 Hz, vibration time: 5 hours) using a vibration tester (ASTM C592-04). The weight of the sample was evaluated using a weight reduction rate in the following equation. The lower the weight reduction rate, the better the dust resistance.

Weight reduction rate=[(weight of sample before vibrations)(weight of sample after vibrations)]/(weight of sample before vibrations)×100

(3) Bursting strength (units: kgf/cm²): To confirm the durability of the manufactured heat insulation sheet, the maximum pressure at which the heat insulation sheet was broken was measured using a Maullen Bursting Tester (Qmesys's QM550A). A 100 mm×100 mm sample was manufactured, the sample was placed on the tester, the heat insulation sheet was broken by expanding a rubber film at the center, and the maximum pressure at which breakage occurred was measured. The higher the bursting strength, the better the durability.

TABLE 1

| | | Heat | Dust | Bursting |
|---|---|---|---|---|
| | Base layer | insulation | resistance | strength |
| Example 1 | Fiber glass mat | 85 | 0.02 | 15 |
| Example 2 | Fiber glass mat | 80 | 0.01 | 16 |
| Example 3 | Fiber glass mat | 75 | 0.02 | 15 |
| Example 4 | Fiber glass mat | 87 | 0.03 | 14 |
| Example 5 | Fiber glass mat | 83 | 0.03 | 18 |
| Comparative | Mica sheet | 83 | 0.02 | 6 |
| Example 1 | | | | |
| Comparative | Mica sheet | 85 | 0.04 | 13 |
| Example 2 | | | | |
| Comparative | Fiber glass mat | 85 | 0.1 | 10 |
| Example 3 | | | | |
| Comparative | Fiber glass mat | 92 | 0.01 | 13 |
| Example 4 | | | | |

As shown in Table 1, the heat insulation sheets of the Examples had desired or improved durability, dust resistance, and heat insulation. On the other hand, Comparative Example 1 including a mica sheet as a base layer had low bursting strength and poor durability. Comparative Example 2 including a mica sheet as a base layer had poor durability and dust resistance. Comparative Example 3 in which the content of the polyvinyl alcohol-based binder was less than 0.5 wt % had poor dust resistance and durability. Comparative Example 4 in which the content of the polyvinyl alcohol-based binder exceeded 20 wt % had poor heat insulation.

A heat insulation sheet for a rechargeable lithium battery according to one example embodiment can increase the stability of a battery module by providing desired or improved durability.

The heat insulation sheet for a rechargeable lithium battery according to one example embodiment can improve the manufacturing processability of the heat insulation sheet and the battery module by providing desired or improved dust resistance.

The heat insulation sheet for a rechargeable lithium battery according to one example embodiment can reduce or suppress heat propagation and/or heat transfer in a module by providing desired or improved heat insulation properties, thereby increasing the stability of the module.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A heat insulation sheet for a rechargeable lithium battery, the heat insulation sheet comprising:
a first base layer; and
an aerogel-containing layer stacked on the first base layer,
wherein the first base layer comprises a fiber mat,
the aerogel-containing layer includes a fibrous support, an aerogel, and a binder, and
in the aerogel-containing layer, the fibrous support is included in an amount ranging from about 5 wt % to about 70 wt %, the aerogel is included in an amount ranging from about 10 wt % to about 90 wt %, and the binder is included in an amount ranging from about 0.5 wt % to about 20 wt %.

2. The heat insulation sheet of claim 1, wherein the heat insulation sheet further comprises a second base layer stacked on the aerogel-containing layer.

3. The heat insulation sheet of claim 1, wherein the aerogel-containing layer comprises a noncontinuous layer independent of the first base layer.

4. The heat insulation sheet of claim 2, wherein the aerogel-containing layer comprises a noncontinuous layer independent of the second base layer.

5. The heat insulation sheet of claim 2, wherein the second base layer comprises a second fiber mat.

6. The heat insulation sheet of claim 1, wherein the fiber mat comprises a non-woven glass fiber sheet.

7. The heat insulation sheet of claim 5, wherein the second fiber mat of the second base layer comprises a non-woven glass fiber sheet.

8. The heat insulation sheet of claim 1, wherein the binder comprises one or more of polyvinyl alcohol, polyethylene glycol, polyacrylamide, polyvinylpyrrolidone, polyurethane, and polyester.

9. The heat insulation sheet of claim 1, wherein the fibrous support comprises glass wool.

10. A rechargeable lithium battery module comprising:
a plurality of battery cells that face each other; and
at least one of the heat insulation sheet of claim 1 between the plurality of battery cells.
